(19) United States
(12) Patent Application Publication
(10) Pub. No.: US 2024/0092220 A1
(43) Pub. Date: Mar. 21, 2024

(54) KEY-OFF ELECTRICAL LOAD MANAGEMENT FOR A VEHICLE

(71) Applicant: GM Global Technology Operations LLC

(72) Inventors: Suresh Gopalakrishnan, Troy, MI (US); Xinyu Du, Oakland Township, MI (US); Chandra S. Namuduri, Troy, MI (US); Lyall Kenneth Winger, Waterloo, Ontario (CA); Gary W. Gantt, JR., Chesterfield Township, MI (US); Anwar Hossain, Troy, MI (US); Kurt R. Garcia, Davisburg, MI (US)

(73) Assignee: GM Global Technology Operations LLC, Detroit, MI (US)

(21) Appl. No.: 17/945,210

(22) Filed: Sep. 15, 2022

(51) Int. Cl. B60L 58/13; B60L 53/62

(52) U.S. Cl. CPC B60L 58/13; B60L 53/62

(57) ABSTRACT

An example method includes receiving a wakeup request from a device from a vehicle. The wakeup request indicates that the device desires to perform a task that consumes electrical power from a battery of the vehicle. The method further includes assigning a priority to the wakeup request. The method further includes queuing the wakeup request according to a wakeup schedule. The method further includes, responsive to a current time satisfying the wakeup schedule, performing the task based at least in part on the priority.

The present disclosure relates to vehicles and particularly to key-off electrical load management for a vehicle.

Modern vehicles (e.g., a car, a motorcycle, a boat, or any other type of automobile) may be equipped with one or more electric motors, such as to drive a wheel(s) of the vehicle. For example, an electric motor can be mechanically coupled to a wheel of a vehicle to apply rotational force to the wheel, creating a driveline. In some examples, a vehicle can include multiple electric motors. The electric motor(s) receives electric power from a rechargeable energy storage system (RESS), which can include one or more batteries for storing electric power. The batteries can be recharged, for example, using a charging station. The RESS can also provide electric power to other systems of the vehicle (e.g., climate control systems, infotainment systems, etc.).

### SUMMARY

In one exemplary embodiment, a method is provided. The method includes receiving a wakeup request from a device from a vehicle. The wakeup request indicates that the device desires to perform a task that consumes electrical power from a battery of the vehicle. The method further includes assigning a priority to the wakeup request. The method further includes queuing the wakeup request according to a wakeup schedule. The method further includes, responsive to a current time satisfying the wakeup schedule, performing the task based at least in part on the priority.

In addition to one or more of the features described herein, or as an alternative, further embodiments of the method may include that performing the task based at least in part on the priority includes comparing the priority to a state of charge threshold for the battery of the vehicle.

In addition to one or more of the features described herein, or as an alternative, further embodiments of the method may include that performing the task based at least in part on the priority includes determining whether the priority satisfies the state of charge threshold for the battery of the vehicle.

In addition to one or more of the features described herein, or as an alternative, further embodiments of the method may include that performing the task based at least in part on the priority includes, responsive to determining that the priority satisfies the state of charge threshold for the battery of the vehicle, performing the task.

In addition to one or more of the features described herein, or as an alternative, further embodiments of the method may include that performing the task based at least in part on the priority includes, responsive to determining that the priority fails to satisfy the state of charge threshold for the battery of the vehicle, preventing the task from being performed.

In addition to one or more of the features described herein, or as an alternative, further embodiments of the method may include that the priority is one of a high priority, a medium priority, or a low priority.

In addition to one or more of the features described herein, or as an alternative, further embodiments of the method may include defining a prohibit schedule, wherein performing the task is based at least in part on the priority, the wakeup schedule, and the prohibit schedule.

In another exemplary embodiment a vehicle is provided. The vehicle includes a battery, a device creating a load on the battery, and a controller. The controller receives a wakeup request from the device from the vehicle. The wakeup request indicating that the device desires to perform a task that consumes electrical power from the battery of the vehicle. The controller further assigns assigning a priority to the wakeup request. The controller further queues the wakeup request according to a wakeup schedule. The controller further, responsive to a current time satisfying the wakeup schedule, performs the task based at least in part on the priority.

In addition to one or more of the features described herein, or as an alternative, further embodiments of the vehicle may include that performing the task based at least in part on the priority comprises comparing the priority to a state of charge threshold for the battery of the vehicle.

In addition to one or more of the features described herein, or as an alternative, further embodiments of the vehicle may include that performing the task based at least in part on the priority comprises determining whether the priority satisfies the state of charge threshold for the battery of the vehicle.

In addition to one or more of the features described herein, or as an alternative, further embodiments of the vehicle may include that performing the task based at least in part on the priority comprises, responsive to determining that the priority satisfies the state of charge threshold for the battery of the vehicle, performing the task.

In addition to one or more of the features described herein, or as an alternative, further embodiments of the vehicle may include that performing the task based at least in part on the priority comprises, responsive to determining that the priority fails to satisfy the state of charge threshold for the battery of the vehicle, preventing the task from being performed.

In addition to one or more of the features described herein, or as an alternative, further embodiments of the vehicle may include that the priority is one of a high priority, a medium priority, or a low priority.

In addition to one or more of the features described herein, or as an alternative, further embodiments of the vehicle may include that the controller further defines a prohibit schedule, wherein performing the task is based at least in part on the priority, the wakeup schedule, and the prohibit schedule.

In another exemplary embodiment a system is provided. The system includes a memory having computer readable instructions and a processing device for executing the computer readable instructions, the computer readable instructions controlling the processing device to perform operations. The operations include receiving a wakeup request from a device from a vehicle. The wakeup request indicates that the device desires to perform a task that consumes electrical power from a battery of the vehicle. The operations further include assigning a priority to the wakeup request. The operations further include queuing the wakeup request according to a wakeup schedule. The operations further include, responsive to a current time satisfying the wakeup schedule, performing the task based at least in part on the priority.

In addition to one or more of the features described herein, or as an alternative, further embodiments of the system may include that performing the task based at least in part on the priority comprises comparing the priority to a state of charge threshold for the battery of the vehicle.

In addition to one or more of the features described herein, or as an alternative, further embodiments of the system may include that the task based at least in part on the priority comprises determining whether the priority satisfies the state of charge threshold for the battery of the vehicle.

In addition to one or more of the features described herein, or as an alternative, further embodiments of the system may include that the task based at least in part on the priority comprises, responsive to determining that the priority satisfies the state of charge threshold for the battery of the vehicle, performing the task.

In addition to one or more of the features described herein, or as an alternative, further embodiments of the system may include that the task based at least in part on the priority comprises, responsive to determining that the priority fails to satisfy the state of charge threshold for the battery of the vehicle, preventing the task from being performed.

In addition to one or more of the features described herein, or as an alternative, further embodiments of the system may include that the priority is one of a high priority, a medium priority, or a low priority.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a block diagram of a vehicle that includes a controller for performing key-off electrical load management for the vehicle according to one or more embodiments described herein;

FIG. 2A is an example graph of a cadenced, consolidated wakeup schedule according to one or more embodiments described herein;

FIG. 2B is a random, unorganized approach to key-off electrical load management in contrast to the approach shown in FIG. 2A;

FIG. 3 depicts a graph showing a categorization of allowed key-off loads according to one or more embodiments described herein;

FIGS. 4A-4C are flow diagrams of methods for key-off electrical load management for a vehicle according to one or more embodiments described herein;

FIGS. 5A and 5B depict wakeup schedules according to one or more embodiments described herein;

FIG. 6 is a flow diagram of a method for key-off electrical load management for a vehicle according to one or more embodiments described herein; and

FIG. 7 is a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein provide for key-off electrical load management for a vehicle. The term “key-off” refers to a condition of a vehicle where the ignition of the vehicle is in an “off” position or state. That is, the vehicle is turned off and is not currently operating. Batteries can be used to provide electrical power to systems and devices of a vehicle while the vehicle is operational (e.g., in a “key-on” condition) and/or while the vehicle is in the key-off condition.

During key-off conditions, certain devices or systems of the vehicle may wake up to perform a task (e.g., sense a condition, perform a test, perform a user-desired function, and/or the like, including combinations and/or multiples thereof), which uses electrical power from the battery of the vehicle. Examples of such systems and devices can include climate control systems, infotainment systems, heated seats, heated steering wheels, window defoggers, and/or the like including combinations and/or multiples thereof. As a result of these wake up events, electrical power is consumed from the battery, reducing the state of charge of the battery.

Unmonitored or uncontrolled electrical loads contribute to battery warranty and may not be able to meet the vehicle technical requirements on the stand time without depleting the battery below a threshold level, for example. Conventional approaches to power management of electrical loads are inefficient. For example, conventional approaches rely on unique algorithms to perform wake up events. A rapidly increasing number of systems/devices desire to consume electrical power from the battery while the vehicle is in the key-off condition, and it is resource intensive to develop a unique algorithm for each system/device to perform a wake up event, which consumes electrical power. Without wakeup structure or restrictions, a vehicle will be woken up frequently, using battery power inefficiently.

One or more embodiments described herein address these and other shortcomings by providing for key-off electrical load management. One or more embodiments described herein provide for power management functionality that transmits synchronization signals to coordinate and schedule wakeups for consumers of battery power when the vehicle is off (e.g., in a “key-off” condition) to conserve the energy of the battery, prolong life of the battery, reduce wear and tear on the battery, and/or the like, including combinations and/or multiples thereof. One or more embodiments described herein sets priorities for key-off loads depending on safety requirements, customer convenience options, and/or the like, including combinations and/or multiples thereof, to allow or disallow wakeups depending on the state of charge of the battery.

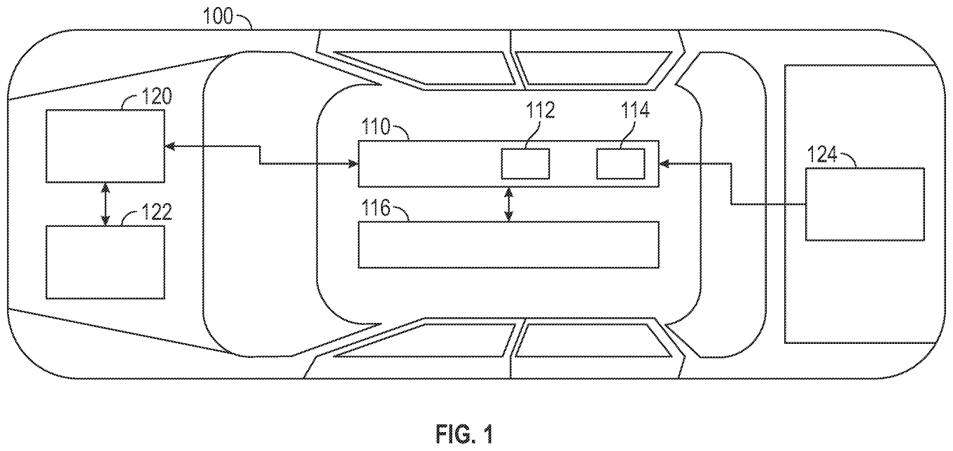

FIG. 1 is a block diagram of a vehicle 100 that includes a controller 110 for performing key-off electrical load management for the vehicle 100 according to one or more embodiments described herein. The controller 110 performs key-off electrical load management for one or more devices 116. As used herein, the devices 116 can include devices, systems, and/or the like including combinations and/or multiples thereof. Examples of the devices 116 include climate control systems, infotainment systems, heated seats, heated steering wheels, window defoggers, and/or the like including combinations and/or multiples thereof

The vehicle 100 further includes an electric motor 120 coupled to a driveline 122. According to one or more embodiments described herein, the controller 110 can control aspects of the electric motor 120 directly and/or indirectly (e.g., via another controller), such as by providing commands to the electric motor 120 to cause the electric motor 120 to take an action (e.g., increase speed, increase torque, decrease speed, decrease torque, etc.).

The vehicle 100 further includes a battery 124. The battery 124 provides electric power to the electric motor 120 and to the devices 116, which can be provided by the controller 110. As an example, the battery 124 includes one or more batteries to receive, store, and supply electric power.

The controller 110 provides power management functionality for the vehicle 100. According to one or more embodiments described herein, the controller 110 transmits synchronization signals to coordinate and schedule wakeups for consumers of battery power (e.g., one or more of the devices 116) when the vehicle is off (e.g., in a “key-off” state) to conserve the energy of the battery 124, prolong life of the battery 124, reduce wear and tear on the battery 124, and/or the like, including combinations and/or multiples thereof. According to one or more embodiments described herein, the controller 110 sets priorities for key-off loads depending on safety requirements, customer convenience options, and/or the like, including combinations and/or multiples thereof, to allow or disallow wakeups depending on the state of charge of the battery 124.

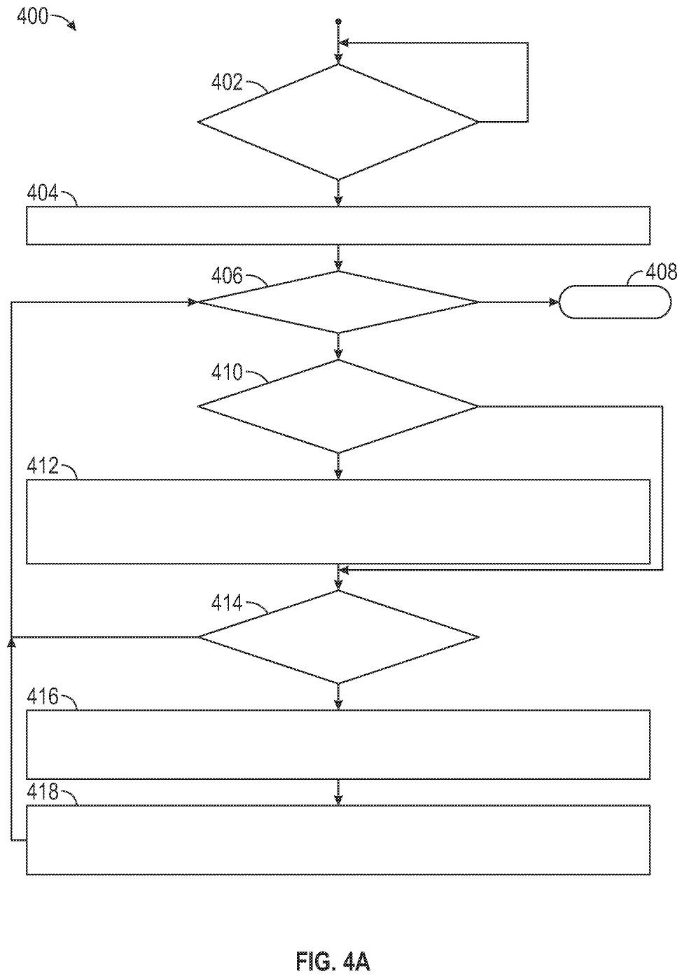

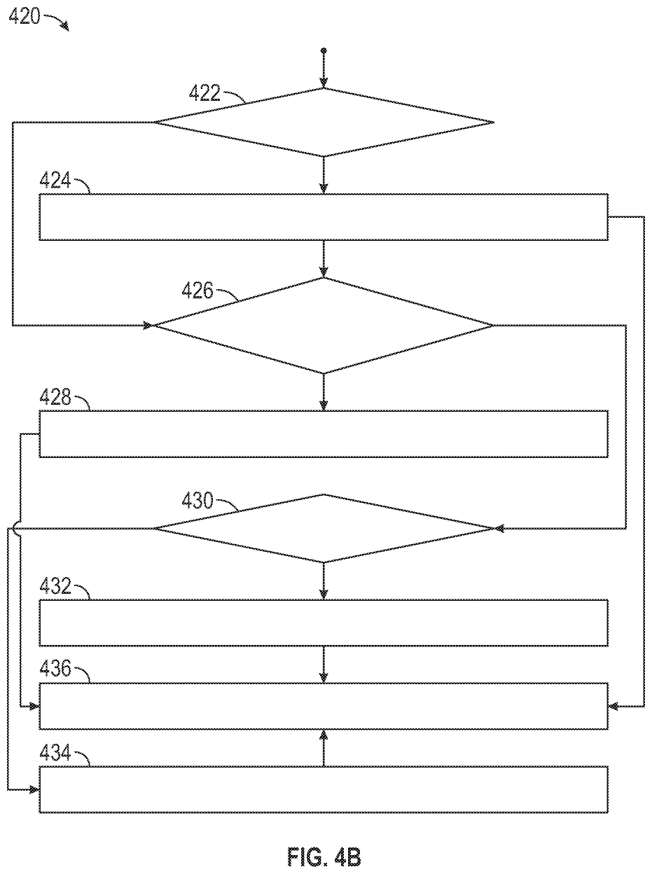

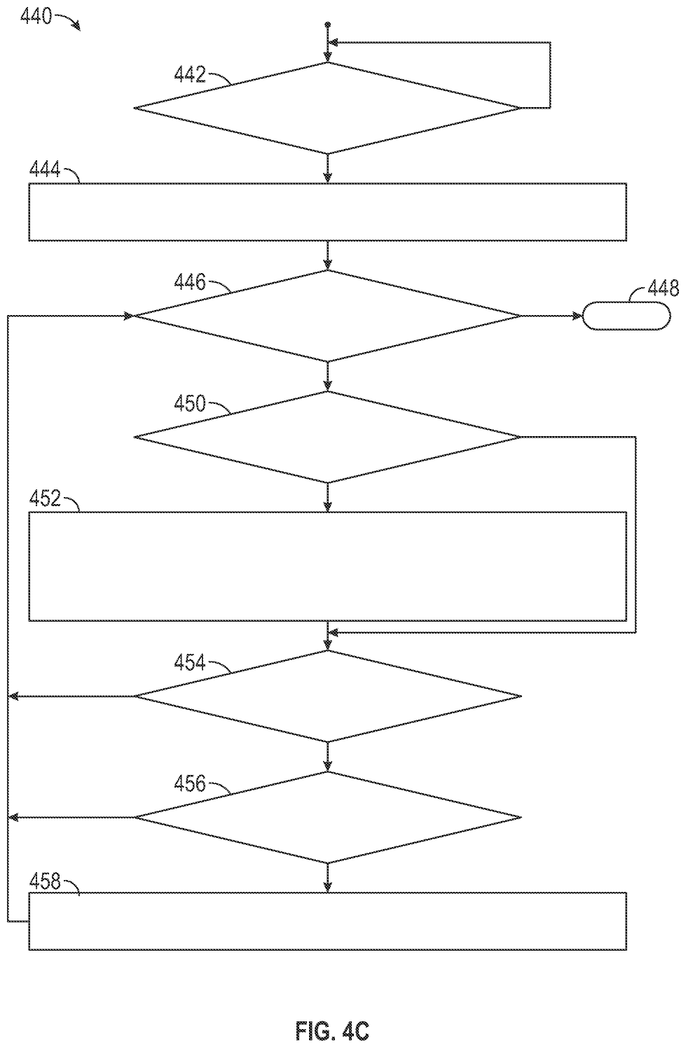

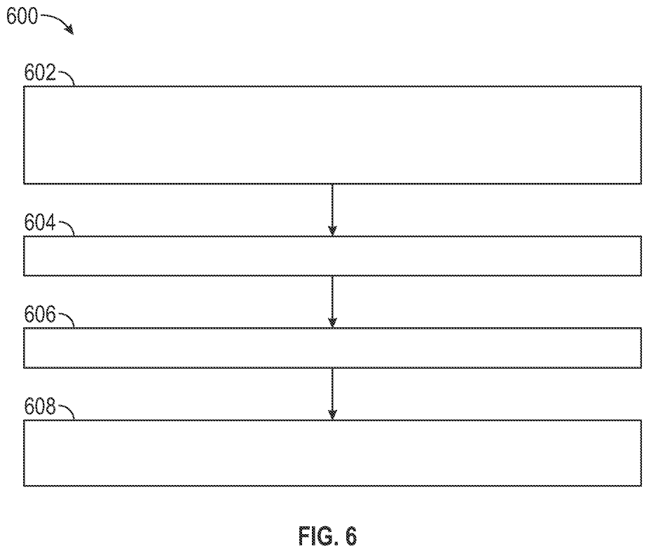

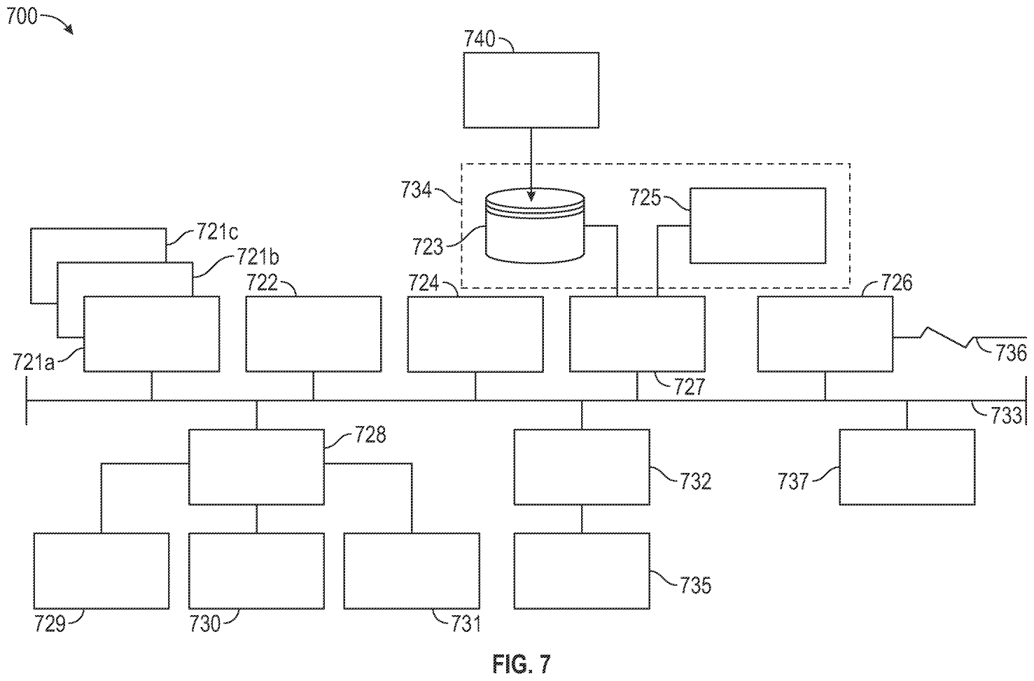

The features and functions of the controller 110 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the features and functions of the controller 110 described herein can be a combination of hardware and programming. According to one or more embodiments described herein, the controller can include a processor 112 (e.g., the processors 721 of FIG. 7, and/or the like including combinations and/or multiples thereof) and a memory 114 (e.g., the random access memory 724 of FIG. 7, the read only memory 722 of FIG. 7, and/or the like including combinations and/or multiples thereof) to store instructions that when executed by the processor 112 cause the processor 112 to perform operations, such as the methods 400, 420, 440 of FIGS. 4A-4C respectively, the method 600 of FIG. 6 and/or the like including combinations and/or multiples thereof.

According to one or more embodiments described herein, the controller 110 acts as a power management module (PMM). The controller 110 synchronizes the “wake up” of various electrical loads during key off conditions (referred to as “key-off loads”). According to one or more embodiments, the priority of the key-off loads is predetermined to reduce electrical power consumption and provide for customer convenience. According to one or more embodiments described herein, a body control module (BCM) (not shown) of the vehicle could host the power management functionality.

According to one or more embodiments described herein, a standard, reserved range of frame IDs (the frame IDs identifying data frames used in a controlled area network (CAN)) are allocated to the controller 110 (e.g., power management module). The standard, reserved range of frame IDs protect the vehicle 100 against changes for each new consumer. New features/devices/systems intending to use electrical power from the battery 124 while the vehicle 100 is in a key off condition can be facilitated by changing a requesting feature/system/device (e.g., a requesting electronic control unit (ECU)) to a plug and play strategy.

One or more embodiments described herein provides a power management procedure to allow or disallow the key-off loads based at least in part on a state of charge of the battery and a priority associated with a wakeup request for each of the key-off loads. The power management procedure queues wakeup requests and wakes up the loads synchronously as determined by the controller 110 depending on the state of charge of the battery 124 and the priority associated with each wakeup request.

According to one or more embodiments described herein, consumers can acknowledge a wakeup for a scheduled activity within the reserved frame IDs. If the controller 110 detects an active feature/device/system (e.g., an active ECU) that is priority restricted, the controller 110 can disallow the load. Examples of disallowing the load include refreshing a priority signal, disconnecting a battery feed through a smart bussed electrical center (e.g., a fuse panel), deactivating a partial network, set a diagnostic trouble code (DTC), and/or the like, including combinations and/or multiples thereof). The event can be logged and sent to a remote location, for example, to alert of an anomaly.

According to one or more embodiments described herein, the power management procedure is dynamically configurable (e.g., based on operating conditions of the vehicle 100, such as ambient temperature, consumer preferences, and/or the like, including combinations and/or multiples thereof). Some key-off wakeups can be reactive, initiated by the customer, are safety/regulatory features that may not be able to adhere to synchronization schedule set by the controller 110, and/or the like, including combinations and/or multiples thereof. In such cases, the controller 110 can allow these random loads (e.g., a key fob being brought close to the vehicle 100) outside the queuing (e.g., scheduling) and priority assignment schemes described herein.

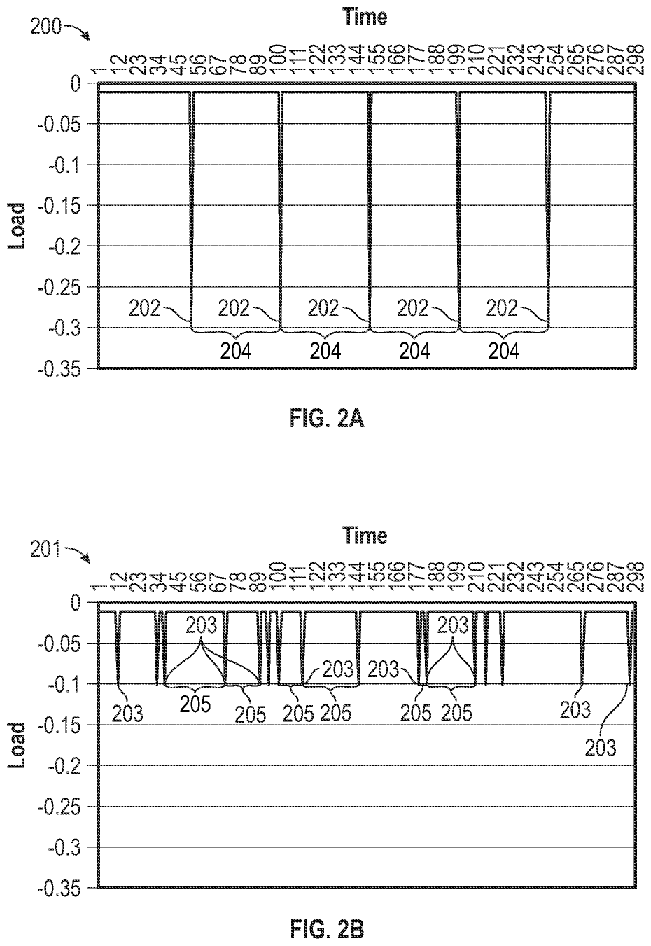

According to an embodiment, the controller 110 can schedule wakeups. For example, as described herein, the controller 110 can transmit synchronization signals to coordinate and schedule wakeups for consumers of battery power (e.g., one or more of the devices 116) when the vehicle is off (e.g., in a “key-off” state). FIG. 2A depicts an example graph 200 of a cadenced, consolidated wakeup schedule according to one or more embodiments described herein. For the graph 200, the horizontal axis represents time (e.g., in seconds), and the vertical axis represents load (e.g., current draw). As shown in the graph 200, each of the spikes 202 occurs on a periodic basis (e.g., intervals 204). As an example, each interval 204 is substantially 50 seconds but can be any suitable period of time in other examples. The graph 200 of FIG. 2A contrasts a graph 201 of FIG. 2B, which shows a random, unorganized approach to key-off electrical load management. In the example of FIG. 2B, the graph 201 shows spikes 203 separated by intervals 205 of varying lengths. For the example graph 201, the horizontal axis represents time (e.g., in seconds), and the vertical axis represents load (e.g., current draw). By comparing the graphs 200, 201, it can be observed that the cadenced, consolidated wakeup schedule of FIG. 2A causes less frequent wakeups and power consumption.

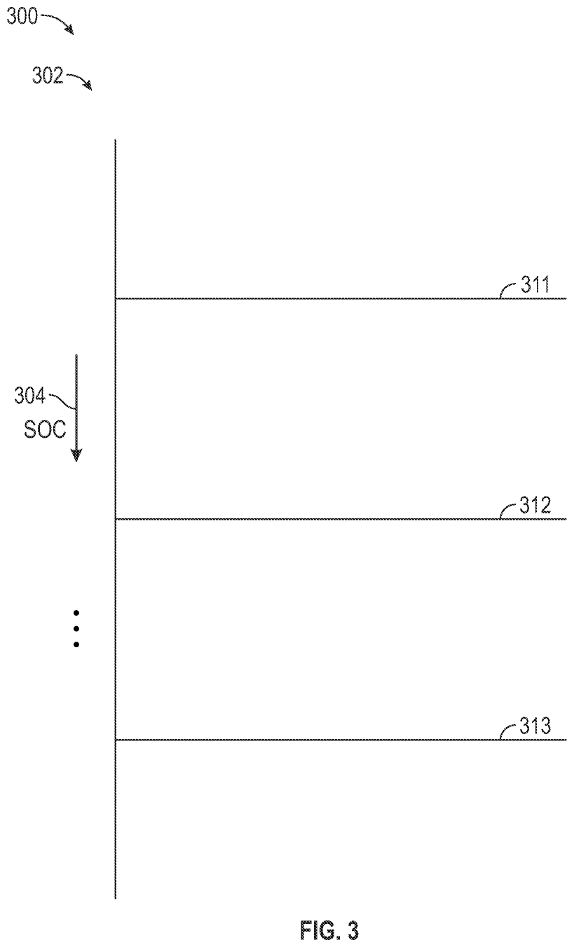

FIG. 3 depicts a graph 300 showing a categorization of allowed key-off loads according to one or more embodiments described herein. In this example, a state of charge (SOC) is plotted vertically, where the state of charge represents the state of charge (as a percentage) of the battery 124. The controller 110 can have one or more thresholds 311, 312 (e.g., a state of charge threshold) which can be used to determine which key-off loads to allow and which to prevent. In the example shown in FIG. 3, two thresholds 311, 312 are used, but more or fewer thresholds can be implemented in other examples. As the state of charge decreases, as shown by the arrow 304, the controller 110 can selectively allow or prevent key-off loads from executing at a wake up period, for example, based on a priority associated with each of the key-off loads.

In FIG. 3, the thresholds 311, 312 represent state of charge levels of the battery 124 above which a key-off load is allowed and below which the key-off load is prevented. For example, wake-ups for high, medium, and low priority key-off loads are allowed above the threshold 311 (e.g., between the threshold 311 and 100% state of charge). For key-off loads between the thresholds 311, 312 (e.g., a lower state of charge than the threshold 311 but a greater state of charge than the threshold 312), high and medium priority key-off loads are allowed and low priority key-off loads are prevented. For key-off loads below the threshold 312 but greater than a state of charge minimum threshold 313, high priority key-off loads are allowed and medium and low priority key-off loads are prevented. Below the state of charge minimum threshold 313, all key-off loads are prevented. The configuration of FIG. 3 is merely one possible example in accordance with one or more embodiments described herein.

Priority examples are now described but are not so limited. When the state of charge is below the state of charge minimum threshold 313, the battery 124 is considered at risk (e.g., vehicle technical specification (VTS) 40-day stand time exceeded, thermal propagation sensor, and/or the like, including combinations and/or multiples thereof). In such cases, safety-related features/devices/systems are allowed but non-safety features/devices/systems are prevented. When the state of charge is between the state of charge minimum threshold 313 and the threshold 312, the battery 124 is considered low (e.g., engine starting system risk, fuel heater filter test, and/or the like, including combinations and/or multiples thereof). In such cases, high priority features/devices/systems are allowed (e.g., regulatory, mobility restricting, high priority corporate initiatives overriding battery warranty concerns, and/or the like, including combinations and/or multiples thereof) while medium and low priority features/devices/systems are prevented. When the state of charge is between the threshold 312 and the threshold 311, the battery 124 is considered approaching a low battery condition. In such cases, high and medium priority features/devices/systems are allowed (e.g., customer satisfaction) while low priority features/devices/systems are prevented. When the state of charge is greater than the threshold 311, the battery 124 is considered nominal, and no restrictions are provided (e.g., remote connectivity features, garage mode, bicycle detection, inadvertent load timer reset, and/or the like, including combinations and/or multiples thereof). In such cases, high, medium, and low priority features/devices/systems are allowed.

Turning now to FIGS. 4A-4C, methods for key-off electrical load management for a vehicle are described. The methods of FIGS. 4A-4C provide for, among other things, prevention of proliferation of power management for a constantly growing list of consumers, condenses key-off wakeup requests to scheduled events, thereby reducing unnecessary, random battery drains, broadcasts a set of signals for key-off consumers to plan allowed events. According to one or more embodiments described herein, based on the battery state of charge, certain features may be scaled down or inhibited over time.

FIG. 4A depicts a flow diagram of a method 400 for power management according to one or more embodiments described herein. The method 400 can be implemented by any suitable system or device, such as the controller 110, the processing system 700 of FIG. 7, and/or the like, including combinations and/or multiples thereof.

At decision block 402, the controller 110 determines whether the power mode switches from on/accessory condition to off condition. If not, the method 400 returns to the beginning and decision block 402 repeats. If the power mode switches to the off condition as determined at decision block 402, the method 400 proceeds to block 404, and the controller 110 initializes variables, such as state of charge and wake up timer, and enters sleep mode. At decision block 406, the controller 110 determines whether the power mode for the vehicle 100 is off. If not, the method 400 exits at block 408. However, if it is determined at decision block 406 that the power mode is off, it is determined whether a synchronize timer event has occurred at decision block 410. That is, the controller 110 determines whether a next wakeup window is occurring (e.g., a current time matches a time of a next scheduled wakeup window (see, e.g., FIG. 2A)). If so, the method 400 proceeds to block 412. At block 412, the controller 110 causes a wake-up, broadcasts time information to associated systems/devices/modules (e.g., the devices 116), broadcasts power management messages, receives power consumption reports from the associated systems/devices/modules, saves the power consumption reports to a buffer, and enters a sleep state. Once the block 412 completes, or responsive to determining that the synchronize timer event has not occurred at decision block 410, the method 400 proceeds to decision block 414.

At decision block 414, the controller 110 determines whether the battery power estimation timer has expired. The battery power estimation timer provides for scheduled state of charge determination. If the battery power estimation timer has not expired, the method 400 returns to decision block 406 and continues. However, if the battery power estimation timer has expired as determined at decision block 414, the controller 110 performs the following at block 416: the controller 110 wakes up, measures a voltage and/or current of the battery 124, loads each of the power consumption reports from the associated systems/devices/modules (see block 412), and estimates a state of charge of the battery 124. At block 418, the controller 110 saves power management information to the buffer (e.g., the memory 114) using the method 420 described with reference to FIG. 4B then returns to sleep.

Particularly, FIG. 4B depicts a flow diagram of a method 420 for power management according to one or more embodiments described herein. The method 420 can be implemented by any suitable system or device, such as the controller 110, the processing system 700 of FIG. 7, and/or the like, including combinations and/or multiples thereof.

At decision block 422, the controller 110 determines whether the state of charge is greater than a threshold T1 (e.g., the threshold 311 of FIG. 3). If so, at block 424, the controller 110 sets a power management message based on a look-up table (see row 1 of the Table below). If at decision block 422 it is determined that the state of charge is not greater than the threshold T1, the controller 110 determines, at decision block 426, whether the state of charge is between the threshold T1 and a threshold T2 (e.g., the threshold 312 of FIG. 3). If so, at block 428, the controller 110 sets a power management message based on the look-up table (see row 2 of the Table below). If at decision block 426 it is determined that the state of charge is between the thresholds T1, T2, the method 420 proceeds to decision block 430. At decision block 430, the controller 110 determines whether the state of charge is greater than an additional threshold (e.g., the state of charge minimum threshold 313 of FIG. 3). If so, at block 432, the controller 110 sets a power management message based on the look-up table (see row N of the Table below). If not, the controller sets an error message at block 434.

Subsequent to completing any of block 424, 428, 432, 434, the method 420 proceeds to block 436 and issues a return message.

The Table described herein is now shown as one example look-up table.

| Row (SOC | | | Amp hours | |
|---|---|---|---|---|
| Level from | Max | Cadence | Allowed | Prohibit Time |
| High to Low) | Priority | Coefficient | (normalized) | (start, stop) |
| 1 (SOC 100%) | N | 1 | 1 | [0, 0] |
| 2 (SOC 85%) | N-1 | 1.5 | 0.5 | [0.5, 0.55] |
| 3 (SOC 70%) | N-2 | 2 | 0.2 | [1, 1.5] |
| . . . | . . . | . . . | . . . | . . . |
| N (SOC 60%) | 1 | 1000 | 0 | [0, 1000] |

FIG. 4C depicts a flow diagram of a method 440 for power management according to one or more embodiments described herein. The method 440 can be implemented by any suitable system or device, such as the controller 110, one or more the devices 116, the processing system 700 of FIG. 7, and/or the like, including combinations and/or multiples thereof. As an example, the method 440 is implemented by the controller 110 in combination with one or more of the systems/devices/modules sending the wakeup requests (e.g., one or more of the devices 116).

At decision block 442, the controller 110 determines whether the power mode switches from on/accessory condition to off condition. If not, the method 400 returns to the beginning and decision block 402 repeats. If the power mode switches to the off condition as determined at decision block 442, the method 440 proceeds to block 444, and the controller 110 initializes variables, such as state of charge and wake up timer, and enters sleep mode. At decision block 446, the controller 110 determines whether the power mode for the vehicle 100 is off. If not, the method 440 exits at block 448. However, if it is determined at decision block 446 that the power mode is off, it is determined whether a synchronize timer event has occurred at decision block 450. That is, the controller 110 determines whether a next wakeup window is occurring (e.g., a current time matches a time of a next scheduled wakeup window (see, e.g., FIG. 2A)). If so, the method 440 proceeds to block 452. At block 452, one or more of the devices 116 wakes up, updates a timer based on time information received from the controller 110 (see block 412 of FIG. 4A), generates a power consumption report (e.g., based on consumption during the current wake up and/or random wake up consumption), resets the random power consumption in a buffer of the one or more devices 116, and returns to a sleep state. Once the block 452 completes, or responsive to determining that the synchronize timer event has not occurred at decision block 450, the method 440 proceeds to decision block 454.

At decision block 454, the controller 110 determines whether a random wake up has been requested (e.g., from a consumer). If not, the method 440 returns to decision block 446 and the method 440 continues. If it is determined that a random wake up has been requested at decision block 454, the method 440 continues to block 456 and determines whether the wake up was requested during a prohibited time (e.g., one of the times between the spikes 202 of FIG. 2 shown by the intervals 204). If so, the method 440 returns to decision block 446 and the method 440 continues. If it is determined that the wake up was not requested during a prohibited time (e.g., a current time matches a scheduled wake up window), the method 440 proceeds to block 458. At block 458, the one or more devices 116 wakes up, calculates a power consumption which is saved to a buffer (not shown), completes a predefined function (e.g., a task that caused or is otherwise associated with the wake up request), and returns to a sleep state. The method 440 returns to decision block 446 and continues.

Additional processes also may be included, and it should be understood that the processes depicted in FIGS. 4A-4C represent illustrations and that other processes may be added or existing processes may be removed, modified, or rearranged without departing from the scope and spirit of the present disclosure.

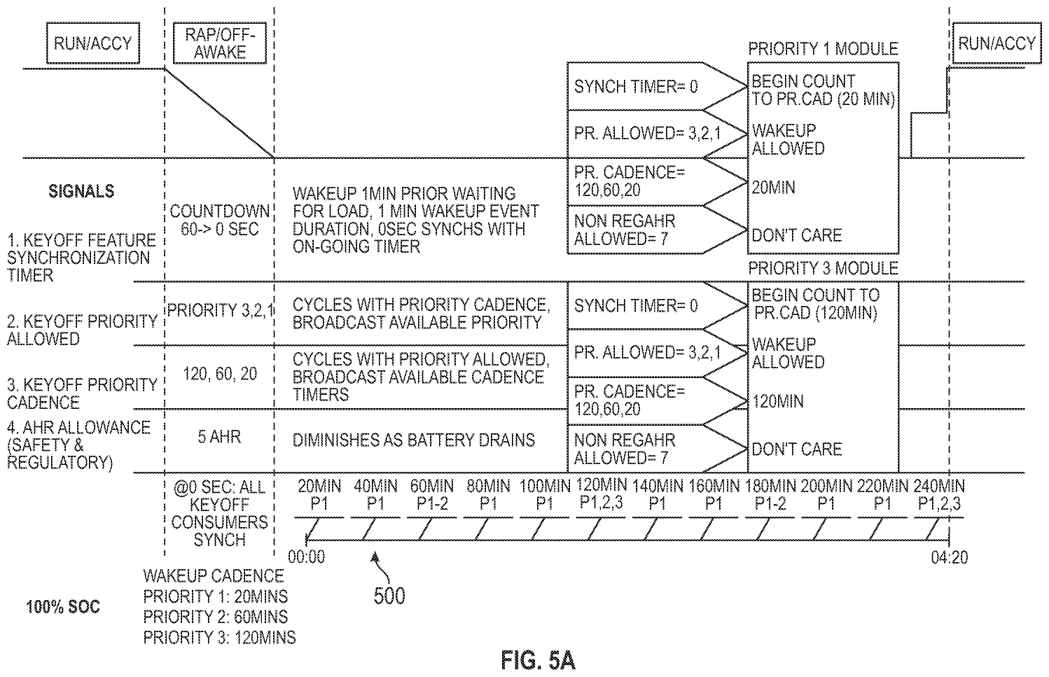

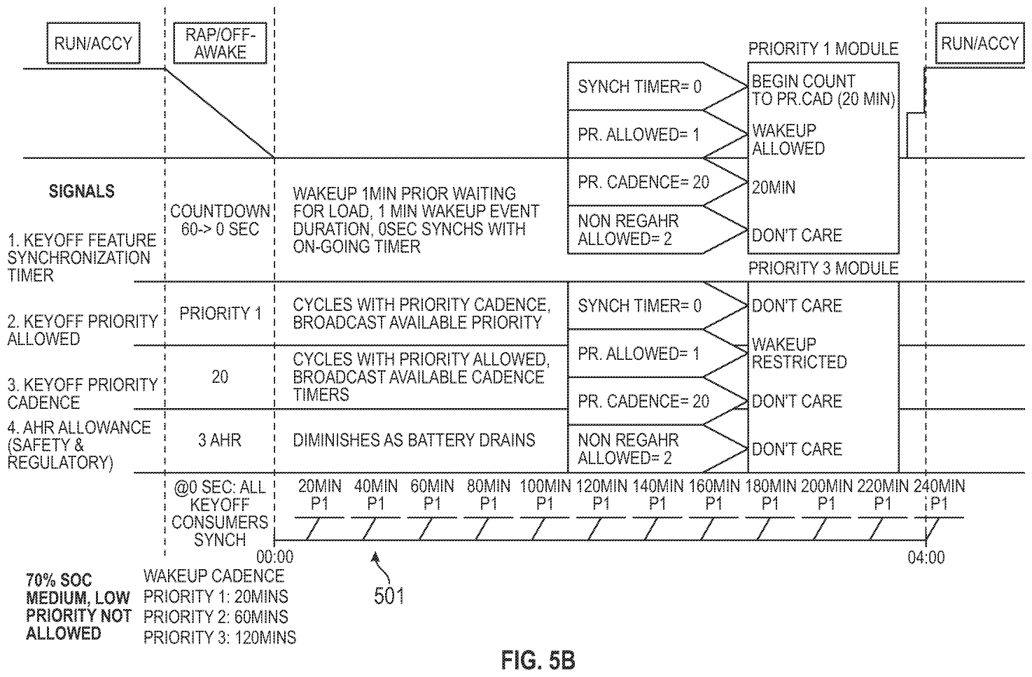

FIGS. 5A and 5B depict wakeup schedules 500, 501 according to one or more embodiments described herein. In the example of FIG. 5A, the state of charge of the battery 124 is substantially 100%, and any priority wake ups can be performed. In contrast, in the example of FIG. 5B, the state of charge of the battery 124 is substantially 70%, and in this condition, high priority (e.g., priority 1) tasks can be performed but not medium and low priority (e.g., priority 2, priority 3) (see, e.g., the Table). As can be seen, FIGS. 5A and 5B provide a wakeup cadence (schedule) for priority 1 tasks of 20 minutes, for priority 2 tasks of 60 minutes, for priority 3 tasks of 120 minutes. These are performed at the suitable wake up windows as shown on the wakeup schedule 500, 501. In the example of FIG. 5A, each of the priority 1, priority 2, and priority 3 tasks are performed according to the wakeup schedule 500. However, in the example of FIG. 5B, the priority 1 tasks are performed according to the wakeup schedule 501 but the priority 2 and 3 tasks are not performed due to the state of charge of the battery 124.

One or more embodiments described herein provide for selecting a number of load functionalities. The selection can be based on one or more of the following scenarios: minimum number of loads enabled when the vehicle is shipped from the manufacturing plant to the dealership; medium level of loads enables when the vehicle is parked at the dealer lot; and full set of loads enabled when the vehicle is sold to a customer. According to one or more embodiments described herein, any load with potential fault can be detected and ignored on further wake up, except the safety critical loads.

One or more embodiments described herein provide for random wakeup load management. Some electric loads may be invoked by customers/consumers. The occurrence time and duration of these events is random. The power consumption of random power loads is hard to be monitored, and such power consumption may impact state of charge and/or parasitic load estimation. According to one or more embodiments described herein, the controller 110 operates some of the loads under low-power mode, when possible. This is to maintain priority while consuming the minimum amount of energy.

One or more embodiment described herein accommodate random wakeup events by issuing, from the controller 110, a wakeup time, wakeup schedule, and prohibit time to functions/devices/systems with wakeup features. For example, after an ignition off event, the functions/devices/systems (with wakeup features) wake up at a certain timestamp to communicate with the controller 110. At this time, the controller 110 broadcasts a message to the functions/devices/systems to specify the allowable wakeup schedule for each priority (e.g., for periodical wakeup load) and a prohibit schedule for each priority (e.g., for random wakeup load). When the state of charge becomes low (e.g., lower than a threshold (see, e.g., FIG. 3)), the controller 110 can extend times between wakeup windows of the wakeup schedule or even disable low priority wakeups. According to one or more embodiments described herein, the controller 110 wakes up at the prohibit time to estimate parasitic load and battery state of charge. According to one or more embodiments described herein, each of the functions/devices/systems can adjust its wakeup schedule and prohibit schedule.

FIG. 6 depicts a flow diagram of a method 600 for key-off electrical load management for a vehicle according to one or more embodiments described herein. It should be appreciated that the method 600 can be performed by any suitable system or device such as the controller 110 of FIG. 1, the processing system 700 of FIG. 7, or any other suitable processing system and/or processing device (e.g., a processor). The method 600 is now described with reference to one or more aspects of FIGS. 1-5C but is not so limited.

At block 602, the controller 110 receives a wakeup request from a device (e.g., one or more of the devices 116) from a vehicle (e.g., the vehicle 100). The wakeup request indicates that the device desires to perform a task that consumes electrical power from a battery (e.g., the batter 124) of the vehicle.

At block 604, the controller 110 assigns a priority to the wakeup request. The priority can be assigned based on a type of the request, based on a requesting origin, and/or the like, including combinations and/or multiples thereof. According to one or more embodiments described herein, the priority is one of a high priority, a medium priority, or a low priority. For example, a request from a function/device/system required by governmental regulation may be assigned a high priority, a request from a sensor for an approach detection system may be assigned a medium priority, and a request from a remote connectivity feature (e.g., a remote unlock command) may be assigned a low priority. It should be understood that other types of requests and other priority levels are possible, and this is merely an example.

At block 606, the controller 110 queues the wakeup request according to a wakeup schedule. That is, the controller 110 stores the wakeup request in a buffer (e.g., the memory 114), such as until a next wakeup window begins.

At block 608, the controller 110 causes the task to be performed based at least in part on the priority responsive to a current time satisfying the wakeup schedule. According to one or more embodiments described herein, performing the task based at least in part on the priority includes comparing the priority to a state of charge threshold (see, e.g., FIG. 3) for the battery of the vehicle. According to one or more embodiments described herein, performing the task based at least in part on the priority includes determining whether the priority satisfies the state of charge threshold for the battery of the vehicle. According to one or more embodiments described herein, performing the task based at least in part on the priority includes, responsive to determining that the priority satisfies the state of charge threshold for the battery of the vehicle, performing the task. According to one or more embodiments described herein, performing the task based at least in part on the priority includes, responsive to determining that the priority fails to satisfy the state of charge threshold for the battery of the vehicle, preventing the task from being performed.

Additional processes also may be included, and it should be understood that the process depicted in FIG. 6 represents an illustration and that other processes may be added or existing processes may be removed, modified, or rearranged without departing from the scope and spirit of the present disclosure.

It is understood that one or more embodiments described herein is capable of being implemented in conjunction with any other type of computing environment now known or later developed. For example, FIG. 7 depicts a block diagram of a processing system 700 for implementing the techniques described herein. In examples, processing system 700 has one or more central processing units (“processors” or “processing resources”) 721a, 721b, 721c, etc. (collectively or generically referred to as processor(s) 721 and/or as processing device(s)). In aspects of the present disclosure, each processor 721 can include a reduced instruction set computer (RISC) microprocessor. Processors 721 are coupled to system memory (e.g., random access memory (RAM) 724) and various other components via a system bus 733. Read only memory (ROM) 722 is coupled to system bus 733 and may include a basic input/output system (BIOS), which controls certain basic functions of processing system 700.

Further depicted are an input/output (I/O) adapter 727 and a network adapter 726 coupled to system bus 733. I/O adapter 727 may be a small computer system interface (SCSI) adapter that communicates with a hard disk 723 and/or a storage device 725 or any other similar component. I/O adapter 727, hard disk 723, and storage device 725 are collectively referred to herein as mass storage 734. Operating system 740 for execution on processing system 700 may be stored in mass storage 734. The network adapter 726 interconnects system bus 733 with an outside network 736 enabling processing system 700 to communicate with other such systems.

A display (e.g., a display monitor) 735 is connected to system bus 733 by display adapter 732, which may include a graphics adapter to improve the performance of graphics intensive applications and a video controller. In one aspect of the present disclosure, adapters 726, 727, and/or 732 may be connected to one or more I/O busses that are connected to system bus 733 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 733 via user interface adapter 728 and display adapter 732. A keyboard 729, mouse 730, and speaker 731 may be interconnected to system bus 733 via user interface adapter 728, which may include, for example, a Super I/O chip integrating multiple device adapters into a single integrated circuit.

In some aspects of the present disclosure, processing system 700 includes a graphics processing unit 737. Graphics processing unit 737 is a specialized electronic circuit designed to manipulate and alter memory to accelerate the creation of images in a frame buffer intended for output to a display. In general, graphics processing unit 737 is very efficient at manipulating computer graphics and image processing, and has a highly parallel structure that makes it more effective than general-purpose CPUs for algorithms where processing of large blocks of data is done in parallel.

Thus, as configured herein, processing system 700 includes processing capability in the form of processors 721, storage capability including system memory (e.g., RAM 724), and mass storage 734, input means such as keyboard 729 and mouse 730, and output capability including speaker 731 and display 735. In some aspects of the present disclosure, a portion of system memory (e.g., RAM 724) and mass storage 734 collectively store the operating system 740 to coordinate the functions of the various components shown in processing system 700.

The descriptions of the various examples of the present disclosure have been presented for purposes of illustration but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A method comprising:
receiving a wakeup request from a device from a vehicle, the wakeup request indicating that the device desires to perform a task that consumes electrical power from a battery of the vehicle;
assigning a priority to the wakeup request;
queuing the wakeup request according to a wakeup schedule; and
responsive to a current time satisfying the wakeup schedule, performing the task based at least in part on the priority.

2. The method of claim 1, wherein performing the task based at least in part on the priority comprises comparing the priority to a state of charge threshold for the battery of the vehicle.

3. The method of claim 2, wherein performing the task based at least in part on the priority comprises determining whether the priority satisfies the state of charge threshold for the battery of the vehicle.

4. The method of claim 3, wherein performing the task based at least in part on the priority comprises, responsive to determining that the priority satisfies the state of charge threshold for the battery of the vehicle, performing the task.

5. The method of claim 3, wherein performing the task based at least in part on the priority comprises, responsive to determining that the priority fails to satisfy the state of charge threshold for the battery of the vehicle, preventing the task from being performed.

6. The method of claim 1, wherein the priority is one of a high priority, a medium priority, or a low priority.

7. The method of claim 1, further comprising defining a prohibit schedule, wherein performing the task is based at least in part on the priority, the wakeup schedule, and the prohibit schedule.

8. A vehicle comprising:
a battery;
a device creating a load on the battery; and
a controller to:
receive a wakeup request from the device from the vehicle, the wakeup request indicating that the device desires to perform a task that consumes electrical power from the battery of the vehicle;
assign a priority to the wakeup request;
queue the wakeup request according to a wakeup schedule; and
responsive to a current time satisfying the wakeup schedule, perform the task based at least in part on the priority.

9. The vehicle of claim 8, wherein performing the task based at least in part on the priority comprises comparing the priority to a state of charge threshold for the battery of the vehicle.

10. The vehicle of claim 9, wherein performing the task based at least in part on the priority comprises determining whether the priority satisfies the state of charge threshold for the battery of the vehicle.

11. The vehicle of claim 10, wherein performing the task based at least in part on the priority comprises, responsive to determining that the priority satisfies the state of charge threshold for the battery of the vehicle, performing the task.

12. The vehicle of claim 10, wherein performing the task based at least in part on the priority comprises, responsive to determining that the priority fails to satisfy the state of charge threshold for the battery of the vehicle, preventing the task from being performed.

13. The vehicle of claim 8, wherein the priority is one of a high priority, a medium priority, or a low priority.

14. The vehicle of claim 8, wherein the controller further defines a prohibit schedule, wherein performing the task is based at least in part on the priority, the wakeup schedule, and the prohibit schedule.

15. A system comprising:
a memory comprising computer readable instructions; and
a processing device for executing the computer readable instructions, the computer readable instructions controlling the processing device to perform operations comprising:
receiving a wakeup request from a device from a vehicle, the wakeup request indicating that the device desires to perform a task that consumes electrical power from a battery of the vehicle;
assigning a priority to the wakeup request;
queuing the wakeup request according to a wakeup schedule; and
responsive to a current time satisfying the wakeup schedule, performing the task based at least in part on the priority.

16. The system of claim 15, wherein performing the task based at least in part on the priority comprises comparing the priority to a state of charge threshold for the battery of the vehicle.

17. The system of claim 16, wherein performing the task based at least in part on the priority comprises determining whether the priority satisfies the state of charge threshold for the battery of the vehicle.

18. The system of claim 17, wherein performing the task based at least in part on the priority comprises, responsive to determining that the priority satisfies the state of charge threshold for the battery of the vehicle, performing the task.

19. The system of claim 17, wherein performing the task based at least in part on the priority comprises, responsive to determining that the priority fails to satisfy the state of charge threshold for the battery of the vehicle, preventing the task from being performed.

20. The system of claim 15, wherein the priority is one of a high priority, a medium priority, or a low priority.
